(19) United States
(12) Patent Application Publication
(10) Pub. No.: US 2008/0052490 A1
(43) Pub. Date: Feb. 28, 2008

(54) Computational resource array

(75) Inventor: Robert C. Botchek, Brookfield, WI (US)

Correspondence Address: SYLKE LAW OFFICES, LLC, 756 N. MILWAUKEE STREET, SUITE 210, MILWAUKEE, WI, 53202, US

(73) Assignee: Tableau, LLC, Waukesha, WI (US)

(21) Appl. No.: 11/510,894

(22) Filed: Aug. 28, 2006

(51) Int. Cl. G06F 15/00

(52) U.S. Cl. 712/11

(57) ABSTRACT

A sea of computational resources includes a number of computational resources, each of which is a member of one or more nearest neighbor pairings. Each nearest neighbor pairing has an upstream neighbor and a downstream neighbor, and each nearest neighbor pairing transfers data between the upstream neighbor and the downstream neighbor using a nearest neighbor protocol. Generally, atomic units of work are selectively passed from the highest upstream computational resource, which can be accessed by a gateway device or the like, to one or more downstream computational resources, one of which eventually performs the work (for example, data processing, etc.) and then passes the computational result from that work upstream. The atomic units of work can be configured and/or formatted as request packets that can utilize a signature word as a work unit identifier. The computational results can likewise be configured and/or formatted as response packets that also utilize the signature word as a work product identifier. Various rules can be enforced to simplify and optimize the computational resources' operation. The configuration of the nearest neighbor pairings can be a 2-dimensional matrix, a octagonal connection array, a star array, or any other configuration that allows appropriate utilization of the computational resources by a host computer or other user of the sea of computational resources.

### CROSS-REFERENCE TO RELATED APPLICATIONS

This application is related to the following: U.S. Ser. No. ______ (Atty. Docket No. 2002-p02) filed Aug. 28, 2006, entitled PASSWORD RECOVERY, the entire disclosure of which is incorporated herein by reference in its entirety for all purposes; U.S. Ser. No. ______ (Atty. Docket No. 2002-p03) filed Aug. 28, 2006, entitled COMPUTER COMMUNICATION, the entire disclosure of which is incorporated herein by reference in its entirety for all purposes; and U.S. Ser. No. ______ (Atty. Docket No. 2002-p04) filed Aug. 28, 2006, entitled OFF-BOARD COMPUTATIONAL RESOURCES, the entire disclosure of which is incorporated herein by reference in its entirety for all purposes.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND

1. Technical Field

The present invention relates generally to data processing systems and, more particularly, to hardware-based systems capable of performing large scale data processing and evaluation.

2. Description of Related Art

Many different types of electronic data require substantial (that is, computationally expensive) processing in various data processing settings and applications. Various configurations and arrangements have been devised to perform such processing, though utilization of the processing, memory and other resources in a computer for such computationally expensive can slow the computer. Moreover, standard computer configurations frequently are not suitable for such processing and are not easily reconfigured for such applications.

Systems, methods and techniques that provide a more effective and computationally inexpensive way to perform otherwise computationally expensive processing would represent a significant advancement in the art. Also, systems, methods and techniques that provide a computer with ready access to computational resources for such computationally expensive work likewise would represent a significant advancement in the art.

### BRIEF SUMMARY

A sea of computational resources includes a number of computational resources, each of which is a member of one or more nearest neighbor pairings. Each nearest neighbor pairing has an upstream neighbor and a downstream neighbor, and each nearest neighbor pairing transfers data between the upstream neighbor and the downstream neighbor using a nearest neighbor protocol. Generally, atomic units of work are selectively passed from the highest upstream computational resource, which can be accessed by a gateway device or the like, to one or more downstream computational resources, one of which eventually performs the work (for example, data processing, etc.) and then passes the computational result from that work upstream. The atomic units of work can be configured and/or formatted as request packets that can utilize a signature word as a work unit identifier. The computational results can likewise be configured and/or formatted as response packets that also utilize the signature word as a work product identifier.

Each pair of computational resources thus includes a first computational resource and a second computational resource coupled to the first computational resource. The first computational resource is configured to operate as an upstream neighbor of the second computational resource and similarly the second computational resource is configured to operate as a downstream neighbor of the first computational resource. Each computational resource communicates with its neighbor using a nearest neighbor protocol, which can be a three phase protocol involving offering a request packet, committing to transfer the request packet and, finally, either transferring the request packet or keeping the request packet for consumption by the upstream neighbor. Various rules can be enforced to simplify and optimize the computational resources' operation. For example, the upstream neighbor can be designated to arbitrate the priority of simultaneous downstream and upstream communication requests and to propagate a clock signal used by the computational resources. As noted above, regarding the sea of computational resources, each upstream neighbor can have multiple downstream neighbors and, likewise, each downstream neighbor can have multiple upstream neighbors. The computational resources can be programmable devices such as FPGAs or the like. Consumption of a single request packet (that is, atomic unit of work) generates a single response packet (that is, computational result) that is passed upstream to a desired location, such as a host computer utilizing the nearest neighbor array. The configuration of the nearest neighbor pairings can be a 2-dimensional matrix, a octagonal connection array, a star array, or any other configuration that allows appropriate utilization of the computational resources by a host computer or other user of the sea of computational resources.

Further details and advantages of the invention are provided in the following Detailed Description and the associated Figures.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a flow diagram according to one or more embodiments of the present invention.

FIG. 2 is a schematic diagram illustrating a host computer system coupled to a hardware accelerator, according to one or more embodiments of the present invention.

FIG. 3 is a schematic diagram illustrating a logic resource such as an FPGA, according to one or more embodiments of the present invention.

FIG. 4 is a schematic and flow diagram illustrating data flow between two logic resources in a sea of computational resources (for example, a processing matrix) according to one or more embodiments of the present invention.

FIG. 5 is a state diagram showing request packet flow in a nearest neighbor pairing according to one or more embodiments of the present invention.

FIG. 6 is a block diagram of a typical computer system or integrated circuit system suitable for implementing embodiments of the present invention, including a hardware accelerator that can be implemented and/or coupled to the computer system according to one or more embodiments of the present invention.

### DETAILED DESCRIPTION

The following detailed description of the invention will refer to one or more embodiments of the invention, but is not limited to such embodiments. Rather, the detailed description is intended only to be illustrative. Those skilled in the art will readily appreciate that the detailed description given herein with respect to the Figures is provided for explanatory purposes as the invention extends beyond these limited embodiments.

Embodiments of the present invention relate to techniques, apparatus, methods, etc. that can be used in interconnecting a plurality of computational resources in a computational unit or the like. The invention is explained in part using a processing matrix in a password recovery system as an exemplary use of the present invention, but the invention is not limited to such an application, as will be appreciated by those skilled in the art. In the exemplary password recovery system, a host computer is coupled to and utilizes a processing matrix (or other type of sea of computational resources) as part of a computational unit, wherein the processing matrix comprises a number of computational resources that are interconnected using a nearest neighbor protocol. The interconnection of computational resources and the techniques available for sharing computational work among the computational resources use one or more embodiments of the present invention.

A specific family of password recovery techniques may be termed “brute force” attacks wherein specialized and/or specially adapted software/equipment is used to try some or all possible passwords. The most effective such brute force attacks frequently rely on an understanding of human factors. For example, most people select passwords that are derived from words or names in their environment and which are therefore easier to remember (for example, names of relatives, pets, local or favorite places, etc.). This understanding of the human factors behind the selection of passwords allows the designers of the “brute force” attacks to focus the attacks on words derived from a “dictionary” which itself is based on and constructed from an understanding of the environment in which the password was selected.

Nonetheless, even intelligent brute force attacks may involve the testing of millions (or more) passwords. Understanding this, the designers of many earlier encryption systems have implemented computationally expensive processes to calculate the cipher key based on the password entered by the user. Interestingly, many of these computationally expensive processes share underlying similarities. For example, a number of common modern-day cipher key schemes apply many iterations of common mathematical hashing algorithms (for example, SHA-1, MD-5, etc.) to the original password. Thousands or even tens of thousands of iterations are not uncommon. Given that each iteration may occupy a modern computer processor for perhaps 1 microsecond or more, a given processor may be able to test only a few dozen to a few thousand passwords per second.

Fortunately, the computations for many such algorithms can be recast in hardware implementations and/or blocks, and numerous such hardware blocks can be set to work in parallel. For many encryption systems, such parallel hardware implementations can perform most or all of the computation required to test each password in a brute force attack, greatly increasing the throughput of the system(s) performing the brute force attacks.

Embodiments of the present invention include systems, apparatus, methods, etc. used to implement a sea of computational resources (in the form of multiple nearest neighbor pairings) for use by a host computer or the like. A computational unit using one or more embodiments of the present invention can generally be characterized as possessing three functional levels and/or blocks: 1) an input such as a front-end interface designed to communicate with the host computer (for example, a host computer on which password recovery or other encryption breaking software and intermediate software are executing), 2) a gateway coupled to the input, where the gateway can include a master device (for example, an FPGA) and a memory and an associated controller (which can be part of the master device), wherein the memory stores both unprocessed data (for example, blocks of passwords or other encrypted data to be processed) and blocks of computational results to be sent to the host computer or elsewhere via the host computer, and 3) coupled to the gateway, a sea of computational resources (referred to herein in some cases as a processing matrix of symmetric logic resources) according to one or more embodiments of the present invention (for example, field programmable gate arrays, or “FPGAs”) configurable to perform specific computations required (for example, encryption schemes being addressed in a password recovery system).

Some embodiments of the present invention are designed to work in conjunction with existing applications, such as password recovery applications. Such password recovery applications can function as primary software in embodiments of the present invention and are already capable of generating lists of password candidates to be tested, to compute cipher keys based on each password candidate, and to test the validity of each cipher key. Earlier password recovery applications have been limited in their performance by the computational capability of the computer processors on which they were executed. In the present invention, the responsibility of calculating cipher keys is outsourced from the password recovery applications to an invoked intermediate software API (Application Programming Interface) to send passwords to one or more hardware accelerators according to embodiments of the present invention. Each hardware accelerator performs the computationally expensive cipher calculations and then returns its results to the intermediate software API, which in turn sends the results to the password recovery applications.

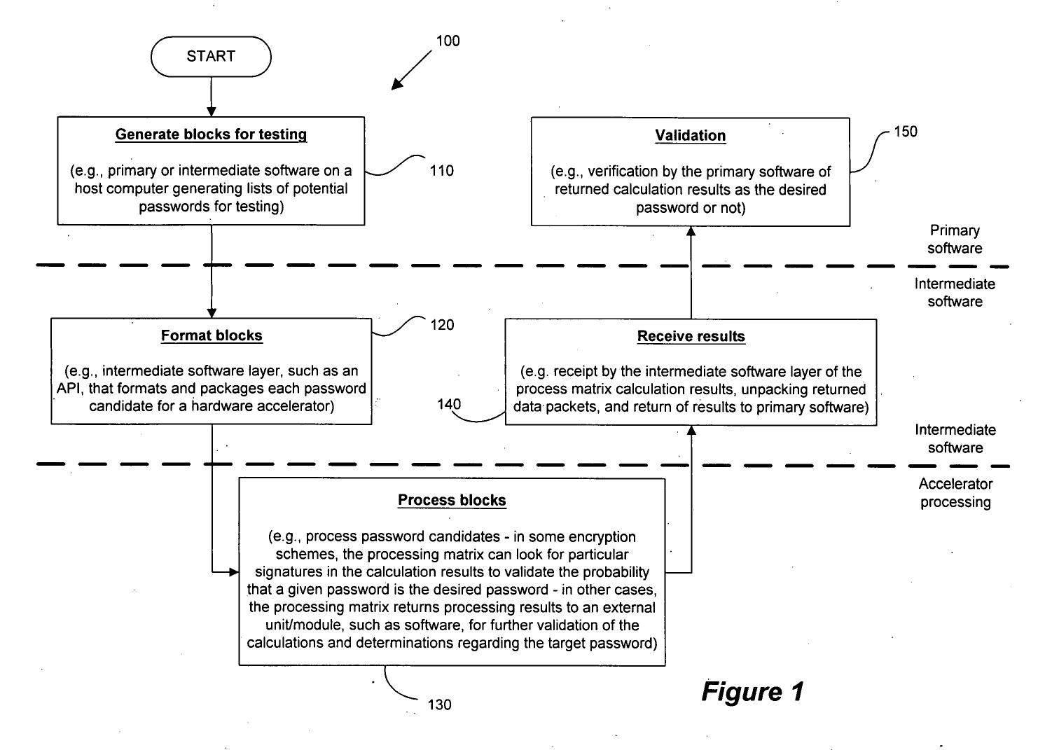

One example of a password recovery system that can utilize the present invention is shown in FIG. 1, where method 100 begins at 110 with data (for example, blocks) being generated for testing. In some cases, this block generation can be performed by software running on a host computer to create password candidates for testing. At 120 the data to be tested can be formatted for test processing. In the example involving password discovery, an intermediate software layer, such as the above-referenced invoked API, can format and package the password candidates for processing by the computational resources in the computational unit coupled to the host computer. The blocks can then be processed at 130, for example by processing the password candidates to try and find a target password. In some embodiments of the present invention, a processing matrix in computational unit can look for particular signatures in the matrix calculation results to validate the probability that a given password candidate is the target password. In other situations, such a processing matrix can return processing results to an external entity or module, such as the primary or intermediate software, for further validation of the calculations and/or determinations regarding the target password.

At 140 the results of processing done at 130 are received for further evaluation or the like, for example receipt by the intermediate software layer for unpacking of the processing results and forwarding the unpacked results to the primary software. Validation and/or verification can be performed at 150. The primary software can verify whether one or more password candidates are indeed the target password sought by the primary software. The intermediate software formats data exchanged between the primary software and the hardware accelerator, whether computational results or password candidates, and the hardware accelerator performs the computationally expensive processing of the candidate data. Other general schemes that would benefit from the available computational unit will be apparent to those skilled in the art.

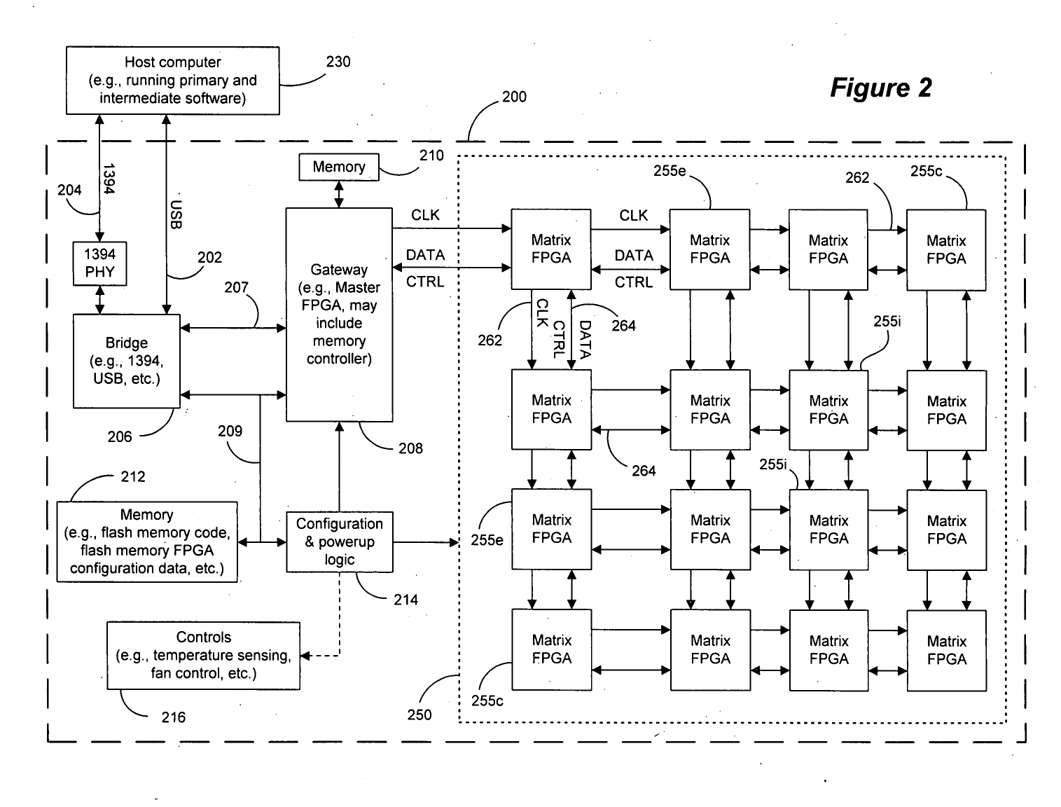

Embodiments of the present invention include a computational unit (for example, a hardware accelerator) that can be coupled to another device (for example, a host computer) via an input and/or interface. The computational unit includes computational resources (such as FPGAs or the like) and can communicate with the host computer using a storage interface protocol. One such computational unit 200 is shown in FIG. 2. In the exemplary system 200 of FIG. 2, two input types are available—a USB input 202 and a FireWire input 204. Typically, at least one such input is coupled to the host computer 230. Phrases such as “coupled to” and “connected to” and the like are used herein to describe a connection between two devices, elements and/or components and are intended to mean coupled either directly together, or indirectly, for example via one or more intervening elements or via a wireless connection, where appropriate.

A bridge 206 connects these inputs 202, 204 to a gateway 208 and transfers data between a host computer interface and a storage interface. In some embodiments, bridge 206 can be an Oxford Semiconductor OXUF922 device, the host computer interface can be a 1394 interface 204 or a USB interface 202, and the storage interface can be an IDE BUS 207. Devices such as the Oxford Semiconductor are inexpensive, readily available, and are well optimized for moving data between the host computer interface and the storage interface. Thus, while use of a storage interface such as IDE BUS 207 may require additional bus interface logic in gateway 208, this additional complexity is more than offset by the cost, availability, and performance advantages afforded by the selection of an appropriate bridge 206.

Gateway 208 can be a device, a software module, a hardware module or combination of one or more of these, as will be appreciated by those skilled in the art. In embodiments of the present invention, gateway 208 can be a device such as an application specific integrated circuit (ASIC), microprocessor, master FPGA or the like, as will be appreciated by those skilled in the art.

A memory 210 is coupled to the gateway 208 and is used for storing (for example, in a DDR SDRAM memory) incoming data to be processed (for example, blocks of password candidates) and for storing computational results from a sea of computational resources 250 (also referred to as a processing matrix or an array herein). In the example of FIG. 2, the bridge 206 and the gateway 208 are coupled to another memory 212 via a processor bus 209 (for example, an ARM bus or the like). Memory 212 can include flash memory containing code and/or FPGA configuration data, as well as other information needed for operation of the system 200. Logic for controlling and configuring the gateway 208 and configuration data in unit 212 can be housed in a module 214. Moreover, additional controls, features, etc. (for example, temperature sensing, fan control, etc.) can be provided at 216, as needed and/or desired.

Gateway 208 controls data flow into and out of array 250. In FIG. 2, computational resources sea 250 has a plurality of logic resources 255 (for example, programmable devices such as FPGAs) coupled to one another as pairings (even where a given computational resource has multiple connections to other computational resources, these are merely multiple pairings) using a “nearest neighbor” configuration and/or protocol, which is explained in more detail below. Each logic resource 255 is provided with one or more clock signals 262 and data/control signals 264. FPGA coupling and use of these signals are described in more detail below. In the embodiment of the computational resource array 250 of FIG. 2, the northwestern-most device 255 is the device farthest upstream in the array. Thus request packets from the gateway 208 flow downstream to all other devices from this northwestern-most position and all response packets in this embodiment flow back to this northwestern-most position in the array 250.

Some embodiments of the present invention provide significant advantages by emulating block-oriented storage devices (for example, a hard disk) when communicating with a host computer. Such emulation radically simplifies a number of software development problems and greatly enhances portability of the processing system of the present invention across different host and operating system environments. Software on the host computer 230 can read from a well-known address (for example, sector 0 is an example of one such well-known address, though there are many alternative addresses that can be used, as will be appreciated by those skilled in the art) to determine the current status and capabilities of the hardware accelerator 200. The computational unit (which, again, may be a hardware accelerator in some embodiments) 200 generally disallows block write operations to the well-known address to prevent standard block-oriented drivers and utilities in the host computer's operating system (O/S) from attempting to format the contents of the perceived block-oriented storage device (that is, the computational unit 200), thus dissuading standard drivers from attempting other input/output (I/O) operations to the computational unit 200 that is emulating a block-oriented storage device. The format of reads from the well-known address is defined in more detail below.

Atomic units of work, referred to herein as “requests,” can be formatted into “request packets” (for example, by intermediate software on the host computer 230) and then concatenated into arrays of request packets (which can be padded to multiples of 512 bytes in length, inasmuch as 512 bytes is a typical block size when transferring data to/from a block-oriented storage device). The padded arrays of request packets are then transmitted to the hardware accelerator 200 using a block write request appropriate for the interface bus through which the hardware accelerator is connected. (The necessary sector address for the block write request can be made known to host software through information returned in response to reading the well-known address.)

The hardware accelerator 200 buffers this block-oriented data transmission in on-board memory 210. The computational unit memory 210 is conceptually organized in the system of FIG. 2 as a FIFO. A computational unit memory controller, which may be part of the gateway 208, extracts successive request packets from the computational unit memory and re-transmits the request packets, typically one at a time, to the logic resources 255 of FPGA matrix 250, which generate computational results from the request packets and send these results to the host computer 230 (for example, to the intermediate software for formatting and/or other processing before substantive review/evaluation by the primary software). In this case, the logic resources format “responses” into “response packets” and transmit these response packets to the computational unit memory controller which in turn stores the response packets in memory 210. As with the memory dedicated to request packets, the memory dedicated to response packets is conceptually organized as a FIFO. As will be appreciated by those skilled in the art, the “packet mode” of operation discussed herein is only one of a wide variety of communication schemes that can be used in connection with embodiments of the present invention, wherein a computational matrix performs one or more tasks. The request packet and response packet type of operational mode is provided herein as an example only.

In the system of FIG. 2, software on the host computer 230 can perform block read requests to the computational unit 200 at periodic intervals. (As with earlier block write requests, the necessary sector address for the block read request can be made known to host software through information returned in response to reading the well-known address.) The computational unit 200 interprets these block read requests as requests to read from the response packet FIFO in memory buffer 210. When reading from the response packet FIFO, the memory controller concatenates response packets into arrays of response packets and then pad the end of the data transfer to a multiple of 512 bytes in length. Further, the memory controller ensures that only whole response packets are returned to the host computer. That is, a single response packet will not be split across two read requests from the host computer.

The computational unit can be designed to run as a hardware accelerator across a number of different host computer and O/S environments. Normally, to make custom hardware such as the hardware accelerator compatible with diverse environments, earlier systems and the like would require the development of customer device drivers for each of the environments. The development of such device drivers is generally complex, time-consuming, and expensive. To eliminate this need, the present invention can use one or more standard block-oriented storage protocols (for example, hard disk protocols) to communicate with the host computer. Current O/S environments have built-in support for devices which support standard block-oriented storage protocols. This built-in support means that application level code on the host computer typically can communicate with a block-oriented storage device without needing custom drivers or other “kernel” level code. For example, in most current O/S environments, an application can query the identity of all attached block-oriented storage devices, “open” one of the devices, then perform arbitrary block read and write operations to that device.

In some embodiments of the present invention, the computational unit is coupled to the host computer via an IEEE-1394 (that is, FireWire) or USB (Universal Serial Bus) interface and can expose itself to the host computer as a storage device. When connected via 1394, the computational unit exposes itself as an SBP-2 (Serial Bus Protocol-2) device, which is the standard way block-oriented storage devices are exposed over 1394. When connected via USB, the computational unit exposes itself as a device conforming to the USB Mass Storage Class Specification, which is the standard way block-oriented storage devices are exposed over USB.

Request and response packets can share a common, generalized header structure. The contents of a given request/response packet payload may vary depending on the nature of the computation being performed by the hardware accelerator. Table 1 provides an exemplary packet structure (all multi-byte integer values such as packet length, signature word, etc. are stored in little-endian byte order, where the least significant byte of each multi-byte integer value is stored at the lowest offset within the packet):

TABLE 1

| Offset | Width | Definition |
|---|---|---|
| 0–1 | 16 bits | Packet Length n |
| | | (including header) |
| 2–5 | 32 bits | Signature Word |
| 6–(n − 1) | n bytes | Packet Payload |

In the example of Table 1, the Packet Length field defines a total packet length of n bytes, where (in this embodiment) n is always an even value greater than or equal to 6. Placing the Packet Length field at the beginning of the packet simplifies hardware design, allowing hardware to detect/determine total packet length by inspecting only the packet's first 16-bit word.

The Signature Word can be a 32-bit project or task “identifier” value and is unique for all packets at any given point in time. Signature words provide an efficient mechanism for associating request and response packets. This feature allows request packets to be processed by an arbitrary logic resource and to be processed in non-deterministic order. Signature Word values can be assigned by software in the host computer when the host software formats the request packets using any algorithm to assign and re-use Signature Word values so long as no two active (that is, outstanding) request packets sent to the same hardware accelerator have the same Signature Word value at the same time.

As an example, software on the host computer may determine that a maximum of M request packets can be outstanding at a time for a given hardware accelerator. Then, software may allocate an array S of M 32-bit storage elements. Software would initialize array S such that:

S[M]=M

where the index of the first element of array S is 0.

Software would then treat array S as a circular buffer, using any appropriate technique, a number of which are well known to those skilled in the art. As it becomes necessary to format a new request packet, the host software will read the value from the head of the circular buffer and use it as the unique Signature Word value for the request. When the host software finishes processing each response packet received from the hardware accelerator, the host software takes the Signature Word value from the response packet and stores it in the tail position of the circular buffer. The head and tail position pointers advance after each such access, as will be apparent to one skilled in the art. As it is likely that response packets will arrive in an order different from the order in which request packets were generated, the order of the values stored in array S (that is, the circular buffer) will tend to become randomized. However, the stored values' uniqueness remains guaranteed, despite any such randomization.

In addition to the array S, software on the host computer can allocate a second array R of M storage elements. Each element in this second array will provide storage for one request packet. Assuming that array S is initialized as shown above, then Signature Word values in array S can be used as indexes into the second array of structures R. As each Signature Word value is unique, the host software is guaranteed that the element thus selected in array R is not currently in use and may be used as storage for a newly formatted request packet.

When software on the host computer receives a response packet from the hardware accelerator, the Signature Word value in the response packet is used to associate the response packet with the element in array R which stores the original request packet. In this way, host software can efficiently associate requests and responses even though responses arrive in a non-deterministic order.

Tables 2 and 3 show examples of request and response packets as they may appear in an implementation of the hardware accelerator specifically designed to do password attack computations:

TABLE 2
Request Packet Format for Password Computation

| Offset | Width | | Definition |
|---|---|---|---|
| 0–1 | 16 | bits | Packet Length n |
| 2–5 | 32 | bits | Signature Word |
| 6–7 | 16 | bits | Password Length p, where p ≧ 1 |
| 8–(8 + p − 1) | p | bytes | Password |
| n − 1 | 0 or 1 | bytes | Packet padding if Password Length |
| | | | p is odd |

TABLE 3
Response Packet Format for Password Computation

| Offset | Width | Definition |
|---|---|---|
| 0–1 | 16 bits | Packet Length n = 26 |
| 2–5 | 32 bits | Signature Word |
| 6–25 | 20 bytes | Cipher key calculated for password (example only) |

Performing a block read request to the well-known address on the hardware accelerator can return a status and capabilities structure as shown in Table 4:

TABLE 4
Block read request status and capability structure

| Offset | Width | Definition |
|---|---|---|
| 0–1 | 16 bits | Structure Length (e.g., 88) |
| 2–3 | 16 bits | Structure Revision (e.g., 0) |
| 4–11 | 8 bytes | Signature String, zero-padded to 8 bytes |
| | | (e.g., “Tableau”) |
| 12–13 | 16 bytes | Model String, zero-padded to 16 bytes |
| | | (e.g., “TACC1441”) |
| 14–15 | 16 bits | Model Identifier in BCD (e.g., 0x1441) |
| 16–23 | 64 bits | Hardware Serial Number (e.g., 0x000ecc1400410001) |
| 24–25 | 16 bits | Firmware Stepping (e.g., 0) |
| 26–37 | 12 bytes | Firmware Build Date (e.g., “Apr. 11, 2006”) |
| 38–49 | 12 bytes | Firmware Build Time (e.g., “18:47:46”) |
| 50–51 | 16 bits | Matrix Technology Code (e.g., 1) |
| 52–53 | 16 bits | Matrix Row Count (e.g., 4) |
| 54–55 | 16 bits | Matrix Column Count (e.g., 4) |
| 56–59 | 32 bits | Buffer Memory Size in bytes (e.g., 67,108,864) |
| 60–63 | 32 bits | Request FIFO Data Available Count in bytes |
| 64–67 | 32 bits | Request FIFO Sector Address |
| 68–71 | 32 bits | Response FIFO Data Available Count in bytes |
| 72–75 | 32 bits | Response FIFO Sector Address |
| 76–79 | 32 bits | Configuration Sector Address |
| 80–83 | 32 bits | Bit-Stream Size in bytes |
| 84–87 | 32 bits | Bit-Stream Sector Address |
| 88–511 | | Zero-Filled |

As above, all multi-byte integer values in Table 4, such as the Matrix Row Count, are stored in little-endian byte order. Fields like Structure Length and Structure Revision are included to allow host software to recognize and adjust for different revisions of the Sector 0 Format (or whatever well-known address is used). Signature String and Model String provide human-readable identifying information to the host software. Model Identifier provides machine readable model information to the host software. Hardware Serial Number identifies each hardware accelerator uniquely.

Firmware Stepping, Firmware Build Date, and Firmware Build Time allow host software to determine automatically the generation of firmware running in the hardware accelerator. Matrix Technology Code, Matrix Row Count, and Matrix Column Count allow host software to determine the FPGA technology and FPGA matrix dimensions. Buffer Memory Size indicates the total amount of buffer memory installed in the hardware accelerator. Request FIFO Data Available Count indicates the maximum number of bytes that may be written to the Request Packet FIFO at the present time and Request FIFO Address indicates the sector address to be used when writing to the Request Packet FIFO. Response FIFO Data Available Count indicates the maximum number of bytes which may be read from the Response Packet FIFO at the present time and Response FIFO Address indicates the sector address to be used when reading from the Response Packet FIFO. Configuration Sector Address identifies the sector address of the Configuration Sector. The Configuration Sector is written by host software to set the current operating parameters of the hardware accelerator.

Bit-Stream Size indicates the maximum length of FPGA configuration bit stream which can be written by the host. Bit-Stream Sector Address identifies the sector address to be used when writing an FPGA configuration bit stream to the hardware accelerator. Upon power-on, SRAM-based FPGAs in the hardware accelerator are not configured. Before the hardware accelerator can process request packets, host software must write an appropriate FPGA configuration bit stream to the hardware accelerator. Each FPGA may be configured with the same or different configuration bit streams as necessary to implement the logic resources as required for a given hardware accelerator and/or computational unit application. Configuration bit streams are developed using FPGA development tools appropriate for the FPGAs as used in the matrix of the hardware accelerator. In some cases, the FPGAs in the processing matrix can be Xilinx XC3S1600E-FG320 components.

Host software can perform block reads and block writes of the Configuration Sector to configure matrix FPGAs in the hardware accelerator according to the format of Table 5:

TABLE 5
Host software block read/write structure

| Offset | Width | Usage | Definition |
|---|---|---|---|
| 0–1 | 16 bits | Read/Write | Control Word |
| 2–3 | 16 bits | Read Only | Status Word |
| 4–5 | 16 bits | Read/Write | FPGA Row Address (0 . . rows − 1) |
| 6–7 | 16 bits | Read/Write | FPGA Column Address |
| | | | (0 . . . columns − 1) |
| 8–11 | 32 bits | Read/Write | FPGA Bit-Stream Length |
| 12–511 | | | Reserved |

The Control Word contains a number of bits which direct firmware in the hardware accelerator to perform FPGA configuration actions. For example, a Control Word may be configured as follows:

| 15 | 8 | 7 | | 0 |
|---|---|---|---|---|
| DEV_EN | | CFG_RST | MTRX_RST | START |

Setting the START bit to “1” triggers the beginning of FPGA configuration for the FPGA identified by FPGA Row Address and FPGA Column Address. The START bit resets automatically to “0” thereafter. Setting DEV_EN to “1” turns on power to the indicated FPGA. DEV_EN should always be set to “1” either before or when attempted to configure the FPGA. Setting the CFG_RST bit to a “1” resets the hardware accelerator configuration logic and restores the FPGA Configuration Bit-Stream address pointer to the beginning of the FPGA Configuration Bit Stream Configuration Buffer. The CFG_RST bit resets to “0” automatically. Setting the MTRX_RST bit to a “1” resets all logic in the FPGA matrix. This operation is global to all FPGAs in the matrix. MTRX_RST should be used, for example, at the end of a hardware acceleration job. The MTRX_RST bit resets to “0” automatically.

The Status Word contains a number of bits which indicate the status of the current FPGA configuration operation. For example, a Status Word may be configured as follows:

| 15 | | 8 | 7 | 0 |
|---|---|---|---|---|
| DEV_EN | DONE | INIT | | BUSY |

BUSY is read as “1” when the hardware accelerator is busy processing a configuration request. INIT and DONE indicate that the FPGA is driving its configuration INIT and DONE signals, respectively. DEV_EN is read as “1” when the FPGA is powered ON. The Status Word bits always reflect the configuration state of the FPGA identified by the row and column in FPGA Row Address and FPGA Column Address, respectively. FPGA Row Address and FPGA Column Address are written by the host to indicate the coordinates of an FPGA within the matrix to be configured.

FPGA Bit-Stream Length indicates the length of the configuration bit-stream that has been written from the host to the FPGA Configuration Bit-Stream Buffer. This indicates the number of FPGA configuration bits that should be copied from the FPGA Configuration Bit-Stream Buffer to the selected FPGA during configuration. The FPGA Configuration Bit-Stream Buffer is the memory that is written when host software performs block write operations to the FPGA Configuration Bit-Stream Sector address. Before writing a new bit stream, host software should always write a “1” to the CFG_RST in the Control Word.

Tasks thus can be split between a host computer and a computational unit according to one or more embodiments of the present invention. The computational unit, while specialized in its ability to receive and process large quantities of data, is nonetheless general and adaptable in its ability to be configured to work on a large number of different tasks (for example, in the case of attacking passwords, encryption algorithms). This flexibility is derived, in part, from the use of FPGAs and/or other programmable devices in one or more implementations of a computational matrix in the computational unit. “SRAM-based” FPGAs, which do not retain their configuration (that is, their programming) across power-down, reflect the practice of building such devices on an underlying matrix of static RAM based memory cells. This FPGA variety is usable in embodiments of the present invention.

Computational units according to the present invention can generally be thought of as possessing three major functional blocks: 1) a front-end interface/input designed to communicate with a host computer or other device (for example, on which application software is executing, 2) a memory unit having a controller coupled to a memory buffer that stores data to be processed by the computational matrix and computational results from the computational matrix to be forwarded to a destination outside the computational unit, and 3) a computational or processing matrix of symmetric logic resources (for example, an FPGA matrix) capable of being configured to perform the specific computations required of each encryption scheme.

The front-end interface according to the present invention allows the computational unit to be coupled to the host computer via one or more interfaces that allow easy connection to a wide variety of host computers. For example, as noted above, FireWire and/or USB interfaces are commonly in use and can be used in connection with embodiments of the present invention.

The memory unit (comprising, for example, a memory and its associated controller, which can be part of the gateway) is responsible for buffering blocks of passwords to be processed. The memory controller and memory are also responsible for buffering the computational results generated for each password so that those results can be transmitted back to the host computer. Other memory configurations can be used, as will be appreciated by those skilled in the art, and those presented in the Figures and herein are provided as examples only.

The processing matrix of symmetric logic resources is built using SRAM-based FPGAs in some embodiments of the present invention. The choice of SRAM-based FPGAs accomplishes two objectives: 1) the logic resources can be reconfigured readily to perform different functions (for example, attacks on different encryption schemes), and 2) SRAM-based FPGAs tend to cost less per unit logic than other FPGA technologies, allowing more logic resources to be deployed at a given cost, and thus increasing the number of password attacks that can be performed in parallel at a given hardware cost. The use of such logic resources also means that the computational matrix of the computational unit can be configured to perform more than one task/function, for example where some FPGAs are programmed to perform a first processing task and other FPGAs in the matrix are configured to perform a second, following task.

In order to maintain high throughput on tasks requiring such, it may be necessary for the host computer to generate a substantial amount of candidate data (for example, tens or even hundreds of thousands of password candidates) at any given time. Using techniques such as those discussed in detail above, each password candidate or other candidate data packet can be formatted into a “request packet” buffered in the memory unit of the hardware accelerator, while the computational results generated for each password candidate or other candidate data are formatted into a “response packet” that also are temporarily buffered in the memory unit prior to transmission to the host computer.

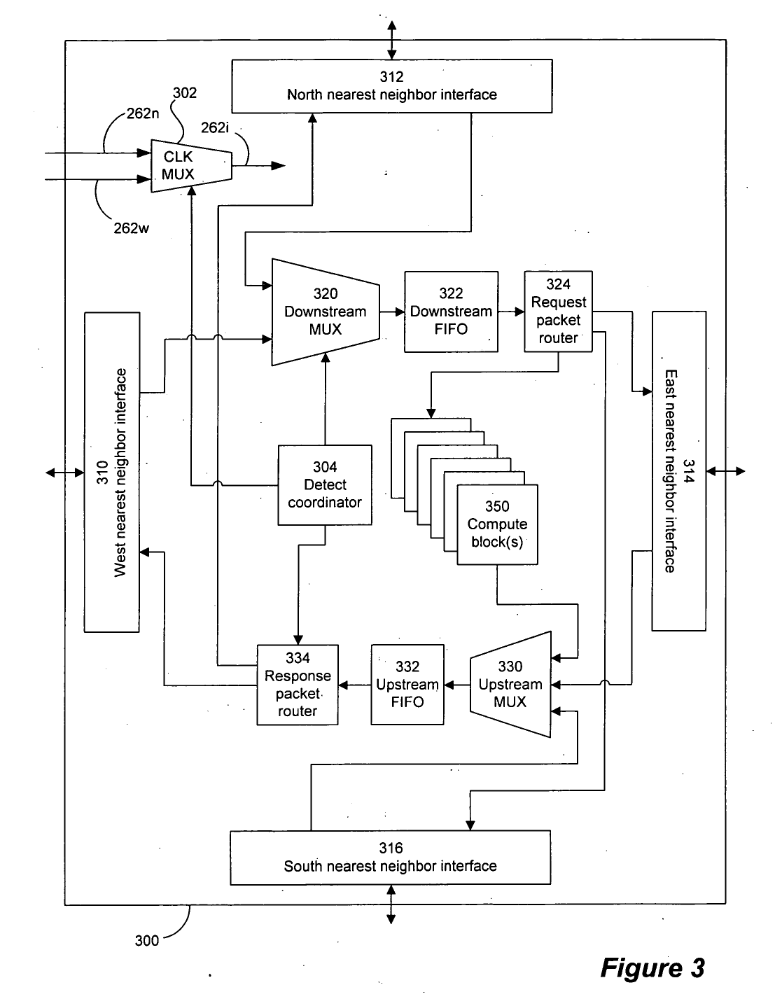

The configuration of a single logic resource 300, such as an FPGA, usable in a computational unit according to one or more embodiments of the present invention is shown in more detail in FIG. 3. Device 300 could be any of the devices 255 of FIG. 2, though one or more neighboring device interfaces might be inactive, depending on the position of device 300 in the processing matrix 250. Every logic resource 300 in the example of FIG. 3 must have at least one clock signal, coming from a west neighbor, a north neighbor, or both. In FIG. 3, two clock signals 262n and 262w are shown as inputs to device 300. A clock signal multiplexer 302 selects which signal to use. A clock multiplexer control signal can be provided by a detection coordination unit 304 or the like, as will be appreciated by those skilled in the art.

Each device 300 can have a west nearest neighbor interface 310, a north nearest neighbor interface 312, an east nearest neighbor interface 314 and a south nearest neighbor interface 316. A request packet available at the west interface 310 or the north interface 312 is available to be sent to a downstream multiplexer 320, which feeds incoming downstream request packets to a downstream FIFO buffer 322. From FIFO buffer 322, downstream request packets are sent to a request packet router 324. As discussed in more detail below, router 324 can either send a downstream request packet to the computational block(s) 350 of device 300 for processing in device 300 or make the request packet available to the east interface 314 and/or south interface 316 for possible processing further downstream (at a neighboring device).

Device 300 can contain one or more computational blocks 350, depending on the space and resources available on a given type of device 300 (for example, an FPGA), the complexity and/or other computational costs of processing to be performed on request packets, etc. In some embodiments, device 300 might contain multiple instantiations of such computational blocks 350 so that multiple request packets can be processed simultaneously in parallel on a single device 300. For purposes of this discussion, it is assumed that device 300 can have such multiple instantiations of a required computational block 350.

For upstream trafficking of response packets, the east interface 314 and south interface 316 can be coupled to an upstream multiplexer 330. Multiplexer 330 also receives completed computational results as response packets from the computational blocks 350 of device 300. Multiplexer 330 provides the response packets it receives to an upstream FIFO buffer 332 and thence to an upstream response packet router 334. Upstream response packet router 334 can send the response packets it receives to either the north interface 312 or the west interface 310 for further upstream migration toward the gateway. Detection coordinator 304 also can control other elements of device 300, such as the downstream multiplexer 320 and upstream response packet router 334.

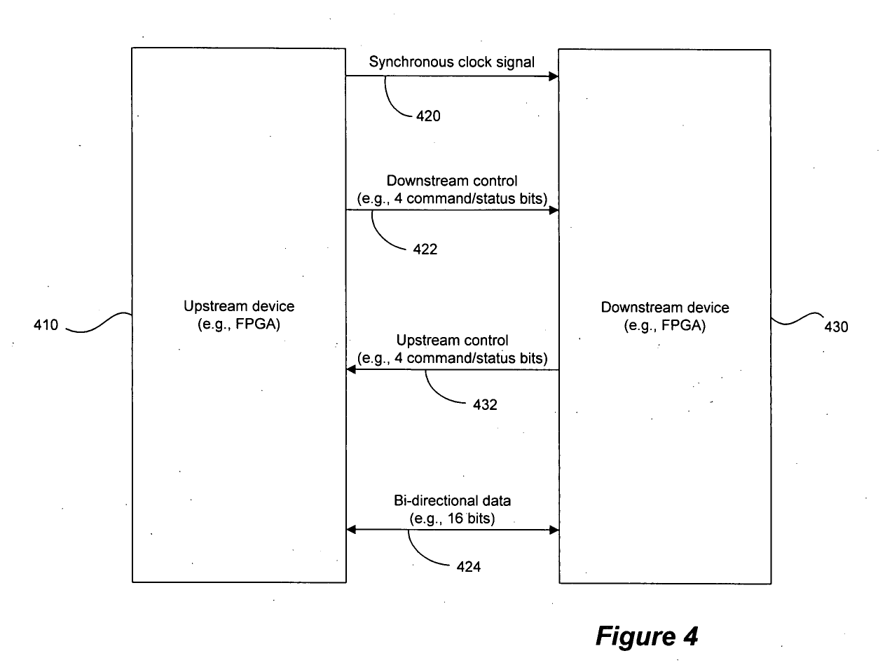

Clock synchronization and control of logic resources such as FPGAs 255 of FIG. 2 can be accomplished in a variety of ways, one of which is shown in FIG. 4. An upstream FPGA 410 can provide a synchronous clock signal 420, downstream control signals 422 and data on a bi-directional signal line 424 (for example, carrying 16 bits) to a downstream FPGA 430. Similarly, downstream FPGA 430 can provide upstream control signals 432 and data on bi-directional signal line 424 to upstream FPGA 410. Downstream control/status can include:

0000—Idle

0001—Downstream transmit request

0010—Downstream transmit wait

0100—Downstream transmit ready

0101—Downstream transmit ready end of packet (EOP)

1001—Upstream receive acknowledgment

1010—Upstream receive wait

1100—Upstream receive ready

1111—No connection

### Similar values can be used for upstream control/status:

0000—Idle

0001—Downstream receive acknowledgment

0010—Downstream receive wait

0100—Downstream receive ready

1001—Upstream transmit request

1010—Upstream transmit wait

1100—Upstream transmit ready

1101—Upstream transmit ready EOP

1111—No connection

In the configuration of FIG. 4, the upstream FPGA 410 is always the arbiter, so that when both the upstream FPGA 410 and the downstream FPGA 430 request a transmit at the same time, the upstream FPGA 410 determines which command will take priority. The downstream FPGA 430 is responsible for propagating the synchronous clock signal to any FPGA(s) further downstream.

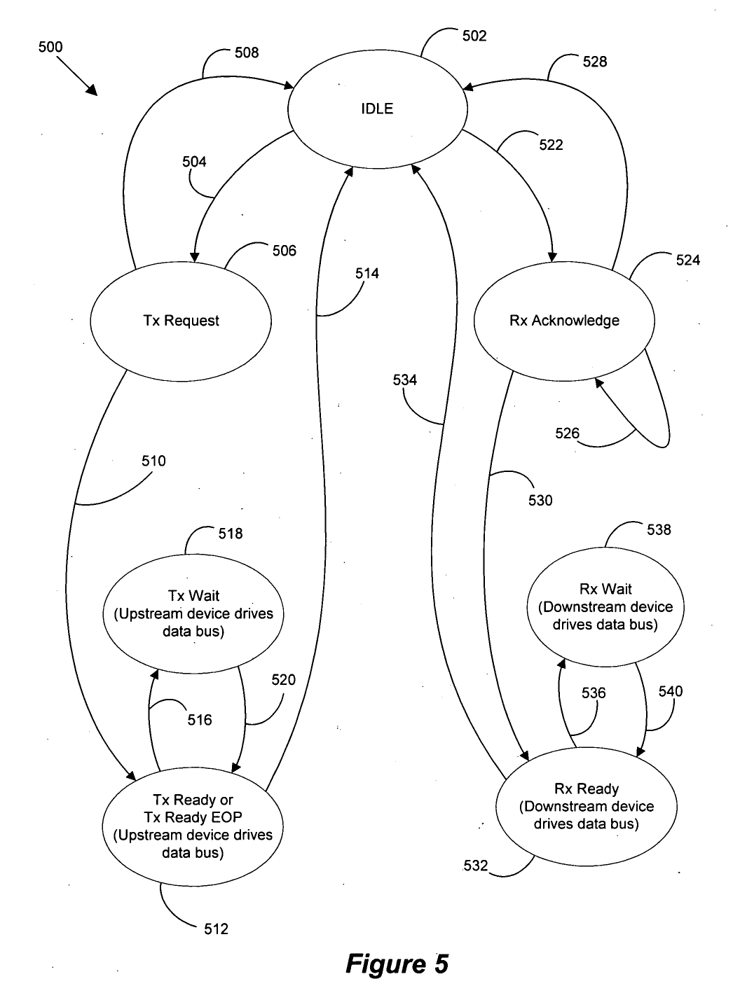

Devices such as FPGAs in the processing matrix can be controlled using any appropriate means, including appropriate state machines, as will be appreciated by those skilled in the art. One example of an upstream state machine 500 is shown in FIG. 5. Starting with the IDLE state 502, an upstream device can request a transmit 504 to a downstream device, after which a transmit request is pending at state 506. From state 506, the upstream device can cancel the transmit at 508 by going back to IDLE 502 or can commit to the transmit at 510 by going to the transmit ready state 512 (which can include “transmit ready” and/or “transmit ready EOP” states, where the upstream device drives the data bus). At this point the upstream device can pause by going at 516 to a transmit wait state 518 (after which the upstream device returns at 520 to the transmit ready state 512) or can complete the transmission at 514, after which the upstream device returns to IDLE 502.

Where the upstream device is receiving response packets from a downstream device, the upstream device can sit in IDLE 502 until a receipt request is received. The upstream device can acknowledge the request at 522 and enter the receive acknowledged state 524. The device can hold this state at 526, cancel the reception at 528 by returning to IDLE 502, or move at 530 to a receive ready state 532 when the downstream device commits to sending the data to the upstream device. The device can wait by moving at 536 to a receive wait state 538, after which it returns at 540 to the receive ready state 532. Once receipt is completed, the device can move at 534 back to the IDLE state 502. In a system such as the one shown in FIG. 5, control/status bits can change on the negative edge of a synchronous clock signal while data can be clocked on the positive edge of the synchronizing clock only when both upstream and downstream devices are signaling “ready.”

Clock synchronization is a major problem in complex digital logic designs such as those found in embodiments of the present invention. To address this problem with earlier systems, a “nearest neighbor” scheme can be used in some embodiments of the present invention. In such a nearest neighbor scheme, each FPGA in the processing matrix only communicates with one or more of its nearest neighbors in the matrix. The terms North, South, East, and West are used herein to designate the 4 nearest neighbors to a given programmable device, using the cardinal points of the compass in their usual two dimensional sense. In the embodiment of the present invention illustrated and explained in detail herein, each computational resource has a maximum of 4 nearest neighbors. However, as will be appreciated by those skilled in the art, many different nearest neighbor configurations can be implemented and used, depending on the type of computational resources employed in the sea of computational resources and the desired computational use(s) and/or purpose(s). For example, the 2-dimensional matrix shown in the Figures can be replaced by a 3-dimensional, multi-layer configuration, a 2-dimensional star array, etc. In each of these alternate embodiments, the nearest neighbor pairings will function analogously and thus provide the multiple pairings described in detail herein.

One “nearest neighbor” architecture that can be employed in embodiments of the present invention is shown in the sea of computational resources 250.of FIG. 2, where each “interior” device 255i is coupled to its 4 neighboring devices, each “edge” device 255e is coupled to 3 of its neighboring devices, and each “corner” devices 255c is coupled to 2 of its neighboring devices. This nearest neighbor architecture of FIG. 2 facilitates the design of a symmetric array of FPGA-based logic resources with the following attributes, among others:
Nearest-neighbors can communicate bi-directionally at high-speed.
Each computational resource (for example, FPGA-based logic resource) is clock synchronized to its nearest neighbor to the “North” or to the “West” in the matrix.
Each computational resource (for example, FPGA-based logic resource) communicates with resources no farther than its nearest neighbors vertically (North and/or South) and/or horizontally (East and/or West).
Request packets flow from the gateway 208 and upper left (northwest-most) device 255 to the lower right (that is, in a generally southeast migration).
The matrix dimensions (that is, the dimensions of any nearest neighbor array and/or configuration) can scale more or less arbitrarily, allowing matrices of greater or fewer resources (through the number of resources and/or through the coupling scheme between resources) to be deployed as best fits the cost and performance requirements of the design.
   While the nearest neighbor scheme shown herein illustrates connections between each FPGA in the sea of computational resources and all of its adjacent neighbors, it is not necessary that all connections be enabled, as will be appreciated by those skilled in the art.

An advantageous characteristic of the nearest neighbor architecture is the available bi-directional transfer protocol. This protocol can govern transfers between each pair of coupled adjacent neighbors in the configuration. Pairings are either vertical (that is, north-south) or horizontal (that is, east-west). In vertical pairings in the embodiment shown in FIG. 2, the neighbor to the North is the master and in horizontal pairings the neighbor to the West is the Master. Likewise, the neighbor to the South or East is the Slave. In this discussion, the Master is also sometimes termed the “upstream” neighbor and transfers towards the master are termed “upstream” transfers. Similarly, the Slave is sometimes termed the “downstream” neighbor and transfers towards the Slave are termed “downstream” transfers.

Each master is responsible for propagating/driving the synchronizing clock to the slave. The master also is responsible for determining the direction of each data transfer on the bi-directional interface. If the master and the slave make simultaneous requests to transfer data, the master arbitrates the conflicting requests and determines the prevailing transfer direction.

As noted above, when a logic resource 255 in the array 250 receives a request packet, the device 255 either processes that packet internally or passes it to a downstream neighbor. Several general definitions and rules can be implemented regarding the downstream flow of request packets (other such definitions and rules will be apparent to those skilled in the art):
1. Each FPGA has one or more computational blocks capable of processing request packets (for example, each programmable device 255 can be programmed to implement 1, 2, 3, 8, 12 or any other number of computational blocks within the programmable device, as will be appreciated by those skilled in the art).
2. Each computational block within an FPGA is always in one of two states: 1) idle—not currently processing a request packet, or 2) busy—actively processing a request packet (also referred to herein as “consuming” a request packet, which generates a response packet containing a computational result).
3. Each FPGA has an input FIFO that can buffer one or more request packets (it is advantageous in most embodiments to have the FIFO large enough to make sure that the computational blocks are idle for as short a time as possible—that is, it generally is good for there to be one or more request packets waiting at all times in each device of the computational resource array).
4. If a computational resource device has an idle computational block, it prefers to consume a request packet rather than passing it to a downstream neighbor.
5. If all computational blocks within an FPGA are busy, the FPGA will offer the request packet to one or more of its downstream neighbors (that is, the neighbor to the South or the neighbor to the East in FIG. 2).
6. If an FPGA has room in its input FIFO, it will agree to accept a request packet from an upstream neighbor.
   Using definitions and rules like those enumerated above, it will be apparent to one skilled in the art that the flow of request packets downstream is selective and not deterministic. Two examples illustrate this characteristic: 1) a given upstream neighbor may offer a request packet to more than one downstream neighbor, and it cannot be known in advance which downstream neighbor will accept the packet, and 2) a given upstream neighbor may offer a request packet to one or more downstream neighbors, but then become capable of consuming the request packet internally before beginning the transmission of the request packet to a downstream neighbor.

To accommodate the non-deterministic flow of request packets throughout the processing matrix or any other computational resource array, a “three-phase” nearest-neighbor protocol can be used (which can be considered in light of the state machine 500 of FIG. 5 in some embodiments of the present invention). In the first phase, an upstream neighbor “offers” a request packet to one or more downstream neighbors. In phase two, the upstream neighbor either commits to the transfer or cancels the transfer. The upstream neighbor can only commit to the transfer if its downstream neighbor is currently indicating that it can accept the transfer. A downstream neighbor signals that it is able to accept a transfer by entering the “request acknowledge” state. Once having entered the “request acknowledge” state, a downstream neighbor cannot leave this state unless and until the upstream neighbor commits to the transfer or cancels the transfer request. The upstream neighbor may cancel a transfer request whether or not the downstream neighbor has entered the request acknowledge state. In phase three, the upstream neighbor begins and ultimately completes the transfer of a request packet to a downstream neighbor.

The flow of response packets from downstream neighbors towards their upstream neighbors can be symmetric to that described for the flow of request packets. In the upstream direction, the downstream (or slave) device is responsible for offering a response packet and then committing to the transfer. The upstream (or master) device is responsible for accepting response packets.

A particularly advantageous characteristic of this architecture is the ability of a device in a sea of computational resources to offer a packet for transfer without specifically committing to the transfer of that packet. This capability allows each device in the processing matrix: 1) to offer packets to more than one nearest neighbor without knowing in advance which neighbor will ultimately accept the packet, and 2) to offer packets to neighbors while still retaining the option to process a packet internally. One skilled in the art will appreciate that the flexibility afforded by this three-phase protocol permits nearly optimal utilization of logic and communication resources within the array.

Each device/FPGA then communicates “upstream” with the device/FPGA from which it receives its synchronizing clock using the bi-directional data interface discussed above. This data interface operates synchronously to the clock. Request packets are passed from the “upstream” neighbor to the “downstream” neighbor, and response packets are passed in the reverse direction. In this manner, the problems of clock synchronization across the hardware accelerator are greatly mitigated. In this scheme, it is necessary only for “nearest neighbors” (that is, upstream/downstream computational resource pairings) to be synchronized with each other.

As noted above, appropriate request packets are fed into the sea of computational resources by the memory controller. If logic resources in a given device/FPGA are available to process the request packet immediately, the request packet is said to be “consumed” by the given device/FPGA (that is, the atomic unit of work is processed to generate a computational result). If no logic resources are presently available to process the request packet, then the device/FPGA will attempt to pass the request packet to one of its downstream neighbors (to the “East” or to the “South” in FIG. 2). This process continues until all logic resources are busy and a given request packet can be passed no further downstream (East or South). As logic resources complete the processing associated with each candidate data block (for example, a password candidate), those logic resources once again become available to process new requests.

The combination of nearest-neighbor architecture and signature words allows request packets to flow fluidly into the matrix and for responses to flow fluidly out of the matrix. In this manner, high logic resource utilization, approaching close to 100%, can be achieved in a highly scalable manner. It will be noted by one skilled in the art that the dimensions of the matrix in the present invention are arbitrary. The size of any desired sea of computational resources and array configuration can be scaled up or down as cost and other constraints permit, resulting in a nearly linear increase or decrease in parallel processing performance.

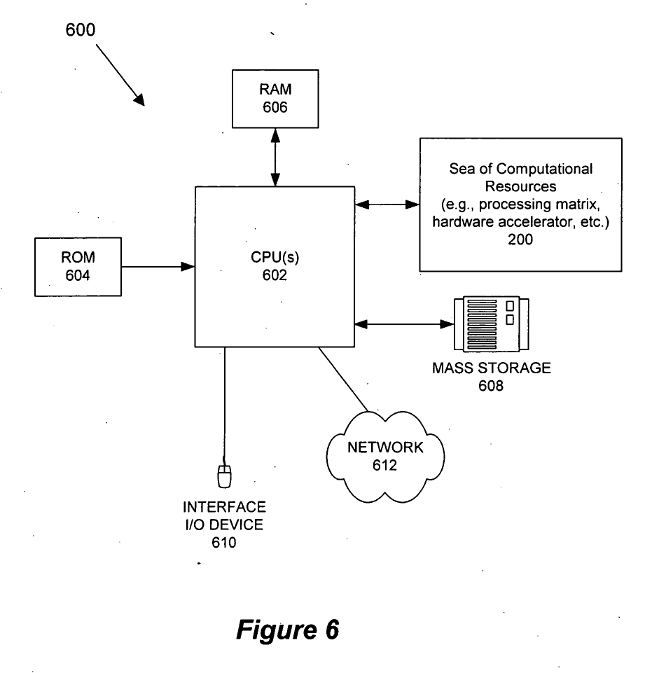

FIG. 6 illustrates a typical computer system that can be used as a host computer and/or other component in a system in accordance with one or more embodiments of the present invention. For example, the computer system 600 of FIG. 6 can execute primary and/or intermediate software, as discuss in connection with embodiments of the present invention above. The computer system 600 includes any number of processors 602 (also referred to as central processing units, or CPUs) that are coupled to storage devices including primary storage 606 (typically a random access memory, or RAM), primary storage 604 (typically a read only memory, or ROM). As is well known in the art, primary storage 604 acts to transfer data and instructions uni-directionally to the CPU and primary storage 606 is used typically to transfer data and instructions in a bi-directional manner. Both of these primary storage devices may include any suitable of the computer-readable media described above. A mass storage device 608 also is coupled bi-directionally to CPU 602 and provides additional data storage capacity and may include any of the computer-readable media described above. The mass storage device 608 may be used to store programs, data and the like and is typically a secondary storage medium such as a hard disk that is slower than primary storage. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 also is coupled to an interface 610 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Moreover, CPU 602 optionally may be coupled to a computer or telecommunications network using a network connection as shown generally at 612. With such a network connection, it is contemplated that the CPU might receive information from the network, or might output information to the network in the course of performing described method steps. Finally, CPU 602, when it is part of a host computer or the like, optionally may be coupled to a computational unit 200 as one embodiment of the present invention that is used to assist with computationally expensive processing and/or other tasks. Apparatus 200 can be the specific embodiment of FIG. 2 or a related embodiment of the present invention. The above-described devices and materials will be familiar to those of skill in the computer hardware and software arts. The hardware elements described above may define multiple software modules for performing the operations of this invention. For example, instructions for running a data encryption cracking program, password breaking program, etc. may be stored on mass storage device 608 or 614 and executed on CPU 602 in conjunction with primary memory 606.

The many features and advantages of the present invention are apparent from the written description, and thus, the appended claims are intended to cover all such features and advantages of the invention. Further, since numerous modifications and changes will readily occur to those skilled in the art, the present invention is not limited to the exact construction and operation as illustrated and described. Therefore, the described embodiments should be taken as illustrative and not restrictive, and the invention should not be limited to the details given herein but should be defined by the following claims and their full scope of equivalents, whether foreseeable or unforeseeable now or in the future.

What is claimed is:

1. A pair of computational resources comprising:
a first computational resource; and
a second computational resource coupled to the first computational resource;
wherein the first computational resource is configured to operate as an upstream neighbor of the second computational resource;
further wherein the second computational resource is configured to operate as a downstream neighbor of the first computational resource; and
wherein each computational resource communicates with its neighbor using a nearest neighbor protocol.

2. The pair of computational resources of claim 1 wherein the upstream neighbor propagates a synchronizing clock signal to the downstream neighbor.

3. The pair of computational resources of claim 1 wherein the nearest neighbor protocol is a three-phase protocol.

4. The pair of computational resources of claim 3 wherein the three-phase protocol comprises:
the upstream neighbor offering a data transmission to downstream neighbor; and
the upstream neighbor selecting to do one of the following:
commit to a previously offered data transmission; or
cancel a previously offered data transmission.

5. The pair of computational resources of claim 4 wherein the data transmission is an atomic unit of work.

6. The pair of computational resources of claim 1 wherein the upstream neighbor arbitrates the priority of simultaneous downstream and upstream communication requests.

7. The pair of computational resources of claim 1 wherein the upstream neighbor is coupled to a plurality of downstream neighbors.

8. The pair of computational resources of claim 1 wherein the downstream neighbor is coupled to a plurality of upstream neighbors.

9. The pair of computational resources of claim 1 wherein the upstream neighbor is configured to do one of the following:
consume an atomic unit of work provided to the upstream neighbor; or
transfer the atomic unit of work provided to the upstream neighbor to the downstream neighbor.

10. The pair of computational resources of claim 9 wherein each atomic unit of work is configured as a request packet, wherein each request packet comprises a signature word.

11. The pair of computational resources of claim 1 wherein the downstream neighbor is configured to transmit computational results generated by the downstream neighbor to the upstream neighbor.

12. The pair of computational resources of claim 11 wherein the computational results are configured to as a response packet, wherein each response packet comprises a signature word.

13. A sea of computational resources comprising a plurality of computational resources, wherein each computational resource is a member of one or more nearest neighbor pairings, wherein each nearest neighbor pairing comprises an upstream neighbor and a downstream neighbor, further wherein each nearest neighbor pairing transfers data between the upstream neighbor and the downstream neighbor using a nearest neighbor protocol.

14. The sea of computational resources of claim 13 wherein the upstream neighbor in each nearest neighbor pairing drives a synchronizing clock to any downstream neighbor of the upstream neighbor.

15. The sea of computational resources of claim 13 wherein the computational resources are arranged in a two-dimensional matrix.

16. The sea of computational resources of claim 17 wherein the two-dimensional matrix is scalable to any desired dimensions.

17. The sea of computational resources of claim 13 wherein an entry computational resource is farthest upstream relative to all other computational resources in the sea of computational resources; and
further wherein the entry computational resource is coupled to a gateway;

18. The sea of computational resources of claim 17 wherein the gateway is configured to transmit atomic units of work to the entry computational resource;
further wherein the atomic units of work are distributed among the plurality of computational resources in the sea of computational resources by selective downstream transmission across nearest neighbor pairings;
further wherein each atomic unit of work is consumed by a single computational resource to generate a computational result; and
further wherein computational resources are delivered to the gateway by successive upstream transmission across nearest neighbor pairings.

19. A method of processing atomic units of work by a sea of computational resources comprising a plurality of individual computational resources interconnected as nearest neighbor pairings, wherein each nearest neighbor pairing comprises an upstream neighbor and a downstream neighbor, the method comprising:
distributing atomic units of work among the plurality of computational resources by selective downstream transmission across pairings using a nearest neighbor protocol;
consuming the atomic units of work by the plurality of computational resources in the sea of computational resources, wherein a consuming computational resource processes an atomic unit of work to generate a computational result; and
transmitting computational results from consumption of atomic units of work to a collection location.

20. The method of claim 19 wherein each atomic unit of work is configured as a request packet comprising a signature word; and
further wherein each computational result is configured as a response packet comprising the signature word.

21. The method of claim 20 wherein each request packet comprises a signature word; and
further wherein each response packet comprises the signature word of the request packet consumed to generate the response packet.

22. The method of claim 19 wherein the atomic units of work are transmitted to the sea of computational resources via a gateway connected to an entry computational resource, wherein the entry computational resource is in a highest upstream position in the sea of computational resources; and
further wherein computational results are propagated upstream towards the entry computational resource across adjacent pairings of nearest neighbor pairings.
